(19) United States
(12) Patent Application Publication
(10) Pub. No.: US 2021/0298331 A1
(43) Pub. Date: Sep. 30, 2021

(54) FRUIT-AND-VEGETABLE DRINK

(71) Applicant: SAMYANG CORPORATION, Seoul (KR)

(72) Inventors: Tae-Chul HAN, Hwaseong-si (KR); Hye Jin LIM, Seongnam-si (KR); Bong Chan KIM, Seoul (KR); Yong-in KIM, Yongin-si (KR); II SEO, Gwangju-si (KR); Seung Mi LEE, Hwaseong-si (KR)

(21) Appl. No.: 17/267,176

(22) PCT Filed: Aug. 10, 2018
(86) PCT No.: PCT/KR2018/009197

§ 371 Date: Feb. 9, 2021

(51) Int. Cl. A23L 2/60; A23L 2/02

(52) U.S. Cl. CPC A23L 2/60; A23V 2002/00; A23L 2/02

(57) ABSTRACT

The present invention relates to a fruit or vegetable drink containing allulose, isomaltooligosaccharide, and fruit-vegetable juice, and can provide a low-calorie fruit or vegetable drink with improved mouthfeel containing a low content of sugar.

### TECHNICAL FIELD

The present invention is a fruit or vegetable drink containing allulose and a manufacturing method, in which use of allulose can achieve improved mouthfeel and significant reduction of sugar content, so as to be used for healthy fruit or vegetable drink having good sensory properties.

### RELATED ART

Fruit or vegetable drinks on the market contain a large amount of saccharides such as monosaccharides or disaccharides. When it is consumed in excess, there is a problem that can cause adult diseases such as dental caries, obesity and diabetes. For the health of people, the government is also encouraging the implementation of “saccharides reduction” in food and beverage compositions. According to the instrumental analysis method of the Food Sanitation Act, ‘saccharides’ means all of monosaccharides and disaccharides present in food, where the monosaccharides are fructose, glucose, and the monosaccharides are sugar, maltose, and lactose. In order to achieve the saccharide reduction in food and beverage, it is inevitable to substitute sugar.

Sugar is one of the representative sweeteners that includes sucrose as its main component and is added to food to impart a sweet taste. Due to the excellent sweetness of sugar, it has been added to various foods and processed foods since the past, and has been regarded as the most preferred sweetener that enhances the taste of food and appetite. However, recently, the problems have been raised as the harmfulness of sugar continues to be revealed. Specifically, excessive intake of sugar is pointed out as a major cause of various lifestyle diseases such as obesity and diabetes, as well as tooth decay, and the need to develop substitute sweeteners is emerging worldwide. Recently, various sweetening materials have been developed, but in consideration of sweetness degree and sweetness quality, the various functional materials, sweeting material and dietary fiber are formulated and commercialized by mixing sugar.

Allulose, which is used as a sweetener to replace sugar, is a C3 epimer of fructose, has a sweetness degree equivalent to 70% of fructose, and is a functional sugar that regulates blood glucose, prevents tooth decay, and inhibits fat synthesis in the liver. Sugar alcohols, which are widely used as sugar substitute sweeteners, have side effects such as causing diarrhea, when consumed over a certain amount. However, allulose has no known side effects. Therefore, there is a growing interest in allulose as a sweetener.

### DISCLOSURE

### Technical Problem

An object of the present invention is to provide a fruit or vegetable drink with reduced saccharides by decreasing saccharides and a method for producing the same.

Another object of the present invention is to provide a fruit or vegetable drink and a method for producing the same, while containing a small amount of monosaccharides or disaccharides, and having excellent sensory properties such as good sweetness and mouthfeel.

### Technical Solution

The present invention relates to a fruit or vegetable drink containing allulose and a method for manufacturing the same, and provides a composition and its preparation method which can reduce sugars and provide a composition with good organoleptic properties and a method for manufacturing the same, by using allulose.

An embodiment of the present invention provides a low-saccharide fruit or vegetable drink comprising allulose, isomaltooligosaccharide, and fruit-vegetable juice.

The fruit or vegetable drinks of the present invention can provide a low-calorie fruit or vegetable drink containing a low content of monosaccharides (excluding rare sugars) or disaccharides, by including allulose and isomaltooligosaccharides as saccharides. In addition, the mouthfeel of fruit-vegetable drinks may be lowered by using allulose, but is maintained at a high level by using isomaltooligosaccharide. Due to the refreshing sensation and flavor improvement effect of allulose, the heating odor of fruit-vegetables generated during the process of concentrating fruit juice is improved, thereby providing a fruit or vegetable drink having rich sensory properties.

For example, allulose and isomaltooligosaccharide may be included in a weight ratio of 1:4 to 4:1, or preferably 1:3 to 3:1 based on the solid content.

The fruit-vegetable juice of the present invention refers to an extract and/or liquid juice of a fruit and/or vegetable, and may additionally include a flesh fragment of a fruit or vegetable. The fruit-vegetable juice is, for example, an extract and/or liquid juice of one or more selected from the group consisting of citrus fruits, apples, grapes, peaches, pineapples, guavas, bananas, mangos, acerola, papayas, passion fruits, Japanese apricot pears, apricots, plums, pomegranates, berries, strawberries, melons, kiwis, tomatoes, carrot, kale, cauliflower, cucumber, parsley, cabbage, sweet pumpkin, celery, lettuce, parsley, fresh vinegar, spinach, beetroot, bell pepper, broccoli, red beet, radish, hemp, and onion, but is not limited thereto. The fruit or vegetable juice may be prepared by concentrating fruit or vegetable extract and/or liquid juice with heating. Although heating odor of fruit or vegetable juice may be generated during the heating process, the present invention masks the heating odor by using the fruit or vegetable juice together with allulose and isomaltooligosaccharide, thereby providing excellent sensory properties.

In the present invention, the term ‘low-saccharides (low-sugar)’ means that the saccharide content is reduced by 10% or more with being compared to the same type of food. More specifically, ‘low saccharides’ means that the saccharide content is lowered to less than 5 g per 100 g of fruit-vegetable drinks or less than 2.5 g per 100 ml of fruit-vegetable drink. ‘Saccharide content’ refers to total weight of five kinds of saccharides of fructose, glucose, sugar, maltose, and lactose.

The allulose may be prepared by chemical synthesis or a biological method using an allulose epimerase, and preferably, may be prepared by a biological method, for example, a microbial or enzymatic reaction. For example, the allulose is provided with a mixed saccharides or is obtained therefrom, and the mixed saccharides are prepared by reacting a fructose-containing raw material, with a composition for producing allulose including at least one selected from the group consisting of an allulose epimerase, microbial cells of a microorganism producing the enzyme, a culture of the microorganism, a lysate of the microorganism, and an extract of the culture or the lysate, or is obtained from the mixed saccharides.

Allulose contained in the fruit-vegetable drinks of the present invention may be in a syrup or powder form. The allulose syrup may be a solution prepared by using allulose in various concentrations. For example, the solid content of allulose in the allulose syrup may be in an amount of 10 to 100% by weight, preferably 70 to 99.99% by weight, or more preferably 90 to 99.99% by weight, based on 100% by weight of the allulose syrup. When allulose powder is used, the solid content of the allulose powder includes allulose having a purity of 90% or more, for example, 90 to 99.99% by weight, or more preferably 95 to 99.99% by weight based on the total content of allulose powder.

The allulose syrup may be obtained through separation, purification, and concentration processes from the allulose alone or from a mixed saccharides. In one embodiment of the present invention, the allulose syrup prepared through the separation and purification process may be liquid allulose syrup having an electrical conductivity of 1 to 50 μS/cm, colorless or pale yellow, and sweet taste.

As an example for the production of allulose in the present invention, a method of preparing allulose including an expression system capable of producing an allulose epimerase with a high expression rate and stability, a generally recognized as safe (GRAS) microorganism using the expression system, and microorganisms and enzymes using the expression system, and the like are described in detail in Korean Patent Nos. 10-1318422 and 10-1656063.

The allulose may be allulose alone or a mixed saccharides containing additional other saccharides, and the examples of the mixed saccharides may contain 1 to 99.9% by weight of allulose based on 100% by weight of the solid content of the total mixed saccharides, and additionally include one or more selected from the group consisting of glucose and/or fructose. When the allulose-mixed saccharides contain fructose and/or glucose, the mixed saccharides may contain 1 to 90% by weight of fructose and/or 1 to 50% by weight of glucose.

Specific example of the mixed saccharides containing allulose includes 5 to 30 parts by weight of allulose, 20 to 50 parts by weight of fructose and 20 to 55 parts by weight of glucose, and 1 to 10 parts by weight of oligosaccharide based on 100 parts by weight of the total solid content of the mixed saccharides. It may contain, or may not contain oligosaccharides. The allulose, fructose and glucose are preferably all D-isomers.

The allulose contained in the fruit or vegetable drink of the present invention may be in an amount of 0.1 to 20% by weight, preferably 0.5 to 15% by weight, or more preferably 0.5 to 10% by weight, based on 100% of the total solid weight of the fruit or vegetable drink solids.

The isomaltooligosaccharide is a liquid or powdery mixed saccharides obtained by filtering, purifying, and/or concentrating a saccharide solution obtained by enzymatic reaction of a saccharide solution or saccharide raw material which is obtained by treating a saccharide raw material with an enzyme to have a basic branched structure of glucose molecules. Isomaltooligosaccharides are a mixture of branched saccharides of disaccharides or more, except monosaccharides (except rare sugars), disaccharides such as sucrose and maltose, straight-chain saccharides of DP4 (4 saccharides) or more, and components of DP8 (8 saccharides) or more. Isomaltooligosaccharides may be a mixed saccharides including at least one branched saccharide selected from the group consisting of Isomaltose (Disaccharide), Kojibiose (Disaccharide), Nigerose (Disaccharide), Panose (Trisaccharide), Isomaltotriose (Trisaccharide), lsomaltotetraose (tetrasaccharides), lsomaltopentaose (5 saccharides), lsomaltohexaose (7 saccharides), and isomaltoheptaose (7 saccharides) and the like.

For example, the isomaltooligosaccharide may be provided with mixed saccharides, and be added with an amount of 10% by weight or more, for example, 10 to 55% by weight, 10 to 50% by weight, 20 to 55% by weight, or 10 to 40% by weight.

The isomaltooligosaccharide mixed saccharides may contain from 20 to 40% by weight of saccharides having a degree of polymerization (DP) of 10 or more, based on 100% by weight of the total solid content of the mixed saccharides. Specifically, the isomaltooligosaccharide mixed saccharides is 10 to 20% by weight or preferably 10 to 15% by weight of a saccharide having DP (degree of polymerization) 3 (trisaccharide), 5 to 15% by weight or preferably 8 to 12% by weight of saccharides having DP4 to DP9, and 20 to 40% by weight or preferably 28 to 40% by weight of saccharides having DP10 or more.

It is characterized that the mixed saccharides composition containing isomaltooligosaccharide (or mixed saccharides containing isomaltooligosaccharide) has a lower content of monosaccharides and disaccharides such as glucose, fructose, and sucrose, a higher content of isomaltooligosaccharide, and significantly increased viscosity, compared to conventional mixed saccharides. For example, based on 100% by weight of the total solid content of the mixed saccharides, monosaccharides (excluding rare sugars) of DP1 may be 10% or less, for example, 1 to 10% by weight or preferably 8% by weight or less, for example 3 to 8% by weight, and the disaccharide of DP2 may be 20% by weight or less, for example 1 to 20% by weight, 5 to 20% by weight or 10 to 20% by weight, or preferably 10% by weight or less, for example, 1 to 10% by weight or 10 to 15% by weight.

The fruit-vegetable drinks of the present invention have excellent sweetness, but the content of monosaccharides (DP1 other than rare sugars) and/or disaccharides (DP2) is significantly reduced, thereby lowering the risk of obesity, diabetes, cardiovascular disease, and other various adult diseases. It can provide the fruit-vegetable beverages containing saccharide content which can be at a level suitable for consumption by people suffering from metabolic syndrome. For example, the isomaltooligosaccharide mixed saccharides may be in an amount of 10 to 30% by weight, or preferably 10 to 25% by weight of the total weight of monosaccharides and disaccharides, based on 100% by weight of the total solid content of the mixed saccharides.

In addition, the fruit or vegetable drink may further contain one or more saccharides selected from the group consisting of sugar, fructose, starch syrup, glucose, rare sugars excluding allulose, sugar alcohols, oligosaccharides, and dextrins. The one or more saccharides to be further mixed may be included at an amount of 0.01 to 20% by weight, preferably 0.1 to 15% by weight, or 0.1 to 10% by weight based on 100% of the total fruit or vegetable drink weight, or may not be contained.

The rare sugars excluding allulose may include at least one selected from the group consisting of tagatose, allose, and altrose. In addition, the oligosaccharide refers to a low-viscosity saccharide in which monosaccharides such as glucose, fructose, or galactose are dehydrated and condensed to form a glycoside bond, and about 2 to 5 monosaccharides are bound. The oligosaccharide is a processed saccharide solution obtained from a saccharide raw material, and includes fructooligosaccharide, isomaltooligosaccharide, galactooligosaccharide, maltooligosaccharide, xylooligosaccharide, genthiooligosaccharide and the like, and may be maltooligosaccharide or isomaltooligosaccharide obtained from starch raw material, galactooligosaccharide obtained from lactose, and fructooligosaccharide obtained from sugar according to the raw materials.

The sugar alcohols may be at least one selected from the group consisting of xylitol, maltitol, erythritol, mannitol, lactitol, inositol, and sorbitol. The dietary fiber may be water-soluble dietary fibers, and the water-soluble dietary fiber may be at least one selected from the group consisting of polydextrose, indigestible maltodextrin, and pectin. The oligosaccharide may be at least one selected from the group consisting of fructooligosaccharide, isomaltooligosaccharide, maltooligosaccharide, and galactooligosaccharide.

The fruit or vegetable drink of the present invention may further include one or more selected from the group consisting of high-intensity sweeteners, acidulants, flavors, pigments, acidity regulators, and preservatives.

The high-intensity sweeteners include aspartame, acesulfame potassium, sodium cyclamate, sodium saccharin, sucralose, stevia sweetener (steviol glycoside, enzyme-treated stevia), dulcine, taumatin, tomatoatin, neotam, rebaudioside (for example, it may be one or more selected from the group consisting of rebaudioside A, rebaudioside D, and rebaudioside M) and monelin. The high-intensity sweeteners may be included in an amount of 0.0001 to 0.5% by weight, or preferably 0.001 to 0.2% by weight, based on 100% by weight of the total fruit drink. The high-intensity sweeteners, for example, sucralose, may cause an undesirable sweetness lingering of sweet aftertaste, and the high-intensity sweeteners such as steviol glycosides, enzyme-treated stevia, or rebaudioside A may cause bitter taste as well as sweetness lingering, but the drink of the present invention has the effect of masking the sweetness lingering and bitterness of the high-intensity sweetness sweetener by using allulose.

The flavors include at least one selected from the group consisting of apple mint flavor, mojito flavor, orange flavor, lime flavor, lemon flavor, mint flavor, apple flavor, grape flavor, raspberry flavor, blueberry flavor, mango flavor, kiwi flavor, and strawberry flavor. The colorants may include at least one selected from the group consisting of a carotenoid-based, flavonoid-based, pyrrole-based, quinone-based natural pigments, and tar color, but is not limited thereto.

For example, the tar color may include an azo pigment, a xanthic-based pigment, a triphenylmethane-based pigment, an indigoid-based pigment, and the like in terms of chemical structure. For example, the tar color may include FD&C Green No.3, FD&C Green No.3 Aluminum Lake, FD&C Red No.2, FD&C Red No.2 Aluminum Lake, FD&C Red No.3, FD&C Blue No.1, FD&C Blue No.1 Aluminum Lake, FD&C Blue No.2, FD&C Blue No.2 Aluminum Lake, FD&C Yellow No.4, FD&C Yellow No.4 Aluminum Lake, FD&C Yellow No.5, FD&C Yellow No.5 Aluminum Lake, FD&C No. 40, FD&C Red No. 40 Aluminum Lake, FD&C Red No. 102, and Food Tar Color Aluminum Lake.

The acidulant may be a variety of commonly used organic acids, or preferably may be at least one selected from the group consisting of citric acid, malic acid, fumaric acid, acetic acid, lactic acid, ascorbic acid, sodium ascorbate, and tartaric acid.

The acidity regulating agent is a commonly used acidity regulating agent, and may include, for example, one or more selected from the group consisting of trisodium citrate, sodium citrate, sodium ascorbate, and glucono-delta-lactone, but is not limited thereto.

The fruit or vegetable drink of the present invention may or may not contain carbonic acid, but is preferably a non-carbonated drink that does not contain carbonic acid.

As another example of the present invention, there is provided a method for producing a fruit or vegetable drink including a step of mixing allulose, isomaltoligosaccharide and fruit-vegetable juice.

The description related to fruit or vegetable drink can be identically applied to the method of manufacturing fruit-vegetable drink.

As a pre-treatment before the step of mixing allulose, isomaltoligosaccharide and fruit-vegetable juice, the preparation method may include obtaining extract, liquid juice or fruit juice of at least one selected from the group consisting of fruits and vegetables; and concentrating the extract, liquid juice, or fruit juice by heating. In the process of concentrating by heating, a heating odor of fruit-vegetable juice may generate, but it can be masked by the composition of the present invention, to produce the fruit or vegetable drink with good sensory properties.

The manufacturing method may include one or more additional processes selected from the group consisting of filtration, sterilization, decolorization, and cooling processes.

### Effect of Invention

The present invention relates to a fruit or vegetable drink comprising allulose, isomaltooligosaccharide, and fruit-vegetable juice, and can provide a low-calorie fruit or vegetable drink containing a low content of saccharides and having an improved mouthfeel.

### MODE FOR INVENTION

The present invention will be described in more detail with reference to the following exemplary examples, but the scope of protection of the present invention is not intended to be limited to the following examples.

### Preparation Example 1. Preparation of Allulose Syrup

Allulose was prepared from a fructose substrate by a biological method substantially the same as that described in Korean Patent No. 10-16173797.

The allulose syrup containing 24-26 (w/w)% allulose was obtained with glucose: fructose: allulose: oligosaccharide=6:67:25:2 from a raw material of 95 wt % fructose at 40 brix.

In order to remove impurities such as color and ionic components, the obtained allulose syrup was treated by passing through a column filled with a cation exchange resin, an anion exchange resin, and a mixed resin of cation exchange resin and anion exchange resin at a rate of twice the volume of the ion exchange resin per hour at room temperature. Then, the high-purity allulose fraction was obtained by performing chromatography with column filled with a calcium (Ca²⁺) type ion exchange resin. The allulose fraction was carried out for the ion purification and the concentration to prepare an allulose syrup containing 95% by weight of allulose and 5% by weight of fructose based on 100% by weight of the solid content of the syrup composition.

The pH, color value, and electrical conductivity of the allulose syrup having an allulose content of 95% by weight were measured and shown in Table 1 below.

TABLE 1

| | Allulose |
|---|---|
| Assortment | 95% syrup |
| pH | 4.41 |
| Color value | 0.039 |
| (Absorbance | |
| 420 nm) | |
| Electrical | 15.13 |
| conductivity | |
| (ms/cm) | |

### Examples 1 to 4. Preparation of Fruit-Vegetable Drinks

Fruit-vegetable drinks were prepared by mixing the components according to the composition (w/w %) of Table 2 below, including the allulose syrup prepared in Preparation Example 1 (Samyang corporation, 70Bx, 95% allulose), and sugar (Comparative Example 1), Isomaltooligosaccharide (Comparative Example 2) or a composition containing only allulose (Comparative Example 3) was contained as a sweetener to prepare the fruit-vegetable drinks.

TABLE 2

| | Compar- | Compar- | Compar- | | | | |
|---|---|---|---|---|---|---|---|
| | ative | ative | ative | Ex- | Ex- | Ex- | Ex- |
| | Example | Example | Example | ample | ample | ample | ample |
| Component | 1 | 2 | 3 | 1 | 2 | 3 | 4 |
| Orange | 13.85 | 13.85 | 13.85 | 13.850 | 13.850 | 13.850 | 13.850 |
| concentrate | | | | | | | |
| (USA, standard | | | | | | | |
| sugar content: 9) | | | | | | | |
| White sugar | 4.20 | — | — | 3.150 | 2.100 | 1.050 | — |
| (Samyang corp.) | | | | | | | |
| Allulose syrup | — | — | 6.000 | 1.500 | 3.000 | 4.500 | 6.000 |
| (Samyang corp.) | | | | | | | |
| Isomaltooligosac | — | 2.50 | — | 0.850 | 1.000 | 1.500 | 2.000 |
| charide | | | | | | | |
| (Samyang corp.) | | | | | | | |
| Citric acid | 0.18 | 0.18 | 0.18 | 0.180 | 0.180 | 0.180 | 0.180 |
| (Samyang corp.) | | | | | | | |
| VitaminC | | | | | | | |
| (Samyang corp.) | 0.02 | 0.02 | 0.02 | 0.020 | 0.020 | 0.020 | 0.020 |
| Rebaudioside A | — | 0.026 | 0.01 | 0.002 | 0.004 | 0.006 | 0.008 |
| Orange flavor | 0.059 | 0.059 | 0.059 | 0.059 | 0.059 | 0.059 | 0.059 |
| Distilled water | Remain- | Remain- | Remain- | Remain- | Remain- | Remain- | Remain- |
| | ing | ing | ing | ing | ing | ing | ing |
| | amount | amount | amount | amount | amount | amount | amount |
| Sum | 100.00 | 100.00 | 100.00 | 100.00 | 100.00 | 100.00 | 100.00 |

Isomaltooligosaccharide-mixed saccharides having the composition shown in Table 3 (based on 100% by weight of solid content per mixture) was used as the isomaltooligosaccharide.

TABLE 3

| | | | | DP4 to | DP10 or |
|---|---|---|---|---|---|
| Unit | DP1 | DP2 | DP3 | DP9 | higher |
| % by | 8.1 | 15 | 20 | 32.6 | 24.3 |
| weight | | | | | |

### Experimental Example 3. Sensory Evaluation

Sensory evaluation was performed on the fruit-vegetable drinks of Examples 1 to 4 and Comparative Examples 1 to 3. The evaluation items of flavor, sweet taste, sour taste, bitter taste, mouthfeel, freshness, heating odor and overall satisfaction were evaluated according to the following evaluation criteria, and the evaluation results are shown in the Table 4 below. A sensory evaluation was performed on 14 male and female panelists in their 20 s to 50 s using a 5-point scale.

[Evaluation Criteria]

Favor: Very low intensity (0 points)-Very high intensity (5 points)

Sweetness: No sweetness (0 points)-Very high sweetness (5 points)

Sour: No sour taste (0 points)-Very high sour taste (5 points)

Bitter taste: No bitter taste (0 points)-Very high bitter taste (5 points)

Mouthfeel: No mouthfeel (0 points)-Very high mouthfeel (5 points)

Fresh: No freshness (0 points)-Very high freshness (5 points)

Heating odor: No heating odor (0 points)-Very high heating odor (5 points)

Taste harmony: No taste harmony (0 points)-Very good taste harmony (5 points)

TABLE 4

| | Compa- | Compa- | Compa- | | | | |
|---|---|---|---|---|---|---|---|
| | rative | rative | rative | | | | |
| Eval- | Ex- | Ex- | Ex- | Ex- | Ex- | Ex- | Ex- |
| uated | ample | ample | ample | ample | ample | ample | ample |
| Item | 1 | 2 | 3 | 1 | 2 | 3 | 4 |
| Flavor | 3.4 | 3.4 | 3.6 | 3.4 | 3.5 | 3.5 | 3.7 |
| Sweet | 3.1 | 3.1 | 3.1 | 3.1 | 3.02 | 3.1 | 3.2 |
| taste | | | | | | | |
| Sour | 2.8 | 2.8 | 2.8 | 2.8 | 2.9 | 2.9 | 2.7 |
| taste | | | | | | | |
| Bitter | 2.5 | 2.5 | 2.0 | 2.5 | 2.3 | 2.2 | 1.9 |
| taste | | | | | | | |
| Mouthfeel | 3.4 | 3.5 | 3.1 | 3.4 | 3.5 | 3.5 | 3.6 |
| Fresh- | 2.9 | 2.8 | 3.4 | 3.0 | 3.2 | 3.2 | 3.5 |
| ness | | | | | | | |
| Heating | 2.6 | 2.6 | 2.2 | 2.5 | 2.3 | 2.3 | 2.1 |
| odor | | | | | | | |
| Taste | 3.4 | 3.2 | 3.3 | 3.4 | 3.7 | 3.7 | 3.6 |
| harmony | | | | | | | |
| Overall | 3.4 | 3.0 | 3.4 | 3.4 | 3.5 | 3.5 | 3.7 |
| satis- | | | | | | | |
| faction | | | | | | | |

As can be seen from the above results, Examples 1 to 4 have good sweetness and excellent mouthfeel which are comparable to those of Comparative Example 1 containing only sugar. It confirm that it is possible to manufacture fruit-vegetable drinks having an excellent sensory properties even though they contain low content of saccharides and are low calorie. In addition, it was confirmed that the heating odor of the fruit-vegetables was improved. In particular, the composition of Example 4 had good sweetness, excellent mouthfeel, and low heating odor, and thus had the remarkably excellent overall satisfaction.

1. A fruit or vegetable drink comprising allulose, isomaltooligosaccharide and fruit-vegetable juice, wherein the allulose and isomaltooligosaccharide are contained in a weight ratio of 1:4 to 4:1 based on the solid content.

2. The fruit or vegetable drink of claim 1, wherein the fruit or vegetable drink has an improved heating odor of fruit or vegetable.

3. The fruit or vegetable drink of claim 1, wherein the fruit or vegetable drink has an improved mouthfeel.

4. The fruit or vegetable drink of claim 1, wherein the allulose is added in a syrup or powder form.

5. The fruit or vegetable drink of claim 4, wherein the allulose is contained in an amount of 0.1 to 20% by weight based on 100% of the total weight of fruit or vegetable drink.

6. The fruit or vegetable drink of claim 1, wherein the isomaltooligosaccharide is added with mixed saccharides including isomaltooligosaccharide at an amount of 10 to 55% by weight of isomaltooligosaccharide based on 100% by weight of solid content of the mixed saccharides.

7. The fruit or vegetable drink of claim 6, wherein the mixed saccharides including isomaltooligosaccharide comprises 20 to 40% by weight of the saccharides having a degree of polymerization (DP) of 10 or more based on 100% by weight of solid content of mixed saccharides.

8. The fruit or vegetable drink of claim 6, wherein the mixed saccharides including isomaltooligosaccharide comprises 10 to 20% by weight of saccharides of DP3, 5 to 15% by weight of saccharides of DP4 to DP9, and 20 to 40% by weight of saccharides of DP10 or more, based on 100% by weight of solid content of the mixed saccharides.

9. The fruit or vegetable drink of claim 6, wherein the mixed saccharides including isomaltooligosaccharide s comprises 1 to 10% by weight of DP1 saccharides excluding rare sugar and 1 to 20% by weight of DP2 saccharides.

10. The fruit or vegetable drink of claim 1, wherein the fruit or vegetable drink further comprises one or more saccharides selected from the group consisting of sugar, fructose, starch syrup, glucose, rare sugars excluding allulose, oligosaccharides excluding isomaltooligosaccharides, sugar alcohols, and dextrins.

11. The fruit or vegetable drink of claim 1, wherein the fruit or vegetable drink further comprises at least one selected from the group consisting of high-intensity sweeteners, acidulants, flavors, colors and preservatives.

12. The fruit or vegetable drink of claim 1, wherein the fruit-vegetable juice is an extract or liquid juice of at least one selected from the group consisting of citrus, apple, grape, peach, pineapple, guava, banana, mango, acerola, papaya, passion fruit, Japanese apricot, pear, apricot, plum, pomegranate, berry, strawberry, melon, kiwi, Tomato, carrot, kale, cauliflower, cucumber, parsley, cabbage, sweet pumpkin, celery, lettuce, parsley, fresh vinegar, spinach, chard, bell pepper, broccoli, red beet, radish, hemp, and onion.

13. A method of preparing a fruit or vegetable drink, comprising a step of mixing allulose, isomaltooligosaccharide and fruit-vegetable juice.

14. The fruit or vegetable drink of claim 1, wherein the isomaltooligosaccharide is added as an improving agent of heating odor or mouthfeel of fruit or vegetable drink.

15. The fruit or vegetable drink of claim 1, which does not contain sugar.
